(19) United States
(12) Patent Application Publication
(10) Pub. No.: US 2008/0277517 A1
(43) Pub. Date: Nov. 13, 2008

(54) Coating film transfer tool

(75) Inventor: Taiji Hyodo, Tokyo (JP)

Correspondence Address: EDWARDS ANGELL PALMER & DODGE LLP, P.O. BOX 55874, BOSTON, MA, 02205, US

(73) Assignee: Tombow Pencil Co, Ltd., Tokyo (JP)

(21) Appl. No.: 11/901,363

(22) Filed: Sep. 17, 2007

(30) Foreign Application Priority Data
Oct. 4, 2006 (JP) JP2006-273431

(51) Int. Cl. G11B 15/00

(52) U.S. Cl. 242/324

(57) ABSTRACT

A coating film transfer tool is provided capable of firmly preventing a non-transcribing portion from being brought about at a transcribed face by coating film detachment of the transcribing tape at an application head and eliminating idle slip at every time of starting to be used. The coating film transfer tool has a protecting cover which is slidable in a front and rear direction between an advanced position in a state of covering the application head and a rear position in a state of exposing the application head at a front end portion of a case main body. The protecting cover is urged in a direction of the advanced position by a spring. There is further provided a tape reel out means for reeling out the transcribing tape to the application head at inside of the case main body. The tape reel out means is moved in cooperation with driving means for moving the protecting cover to the rear position when operating the driving means in starting to be used.

### BACKGROUND OF THE INVENTION

1. Field of the Invention

The present invention relates to a coating film transfer tool provided with a protecting cover for protecting a transcribing tape when not used. Particularly it relates to a coating film transfer tool capable of preventing coating film detachment of a transcribing tape in an application head when started to be used.

2. Description of the Related Art

There is publicly known (e.g. JP-A-2004-268322) a coating film transfer tool in which a supply reel and a take-up reel are provided inside of a case main body, a transcribing tape wound around the supply reel is reeled by the take-up reel by way of a transcribing roller of an application head projected from a front end opening of the case main body, a protecting cover for covering the application head is provided at a front end portion of the case main body, the protecting cover is slidable in a front and rear direction between an advanced position in a state of covering the application head and a rear position in a state of exposing the application head, and is urged in a direction of the advanced position by a spring.

Such a coating film transfer tool is made to be usable by moving back the protecting cover to inside of the case main body against an urge force of the spring by an operation of pressing it against a transcribed face in transcribing to thereby expose the transcribing tape along with the application head.

On the other hand, when not used, the protecting cover is moved forward by the urge force of the spring to cover the application head, thereby, the transcribing tape is protected and a coating film is prevented from being erroneously transcribed onto other portion.

However, according to the prior coating film transfer tool, when used, transcribing is carried out by extracting the transcribing tape from the supply reel by a friction resistance produced between the transcribed face and a coating film coated onto the transcribing tape when the application head is slid while being pressed to the transcribed face. Therefore, in transcribing, a tensile force is operated to the transcribing tape between the supply reel and the transcribing roller due to a friction resistance by an adhering force of the coating film between layers of the transcribing tape wound around the supply reel, and the transcribing tape is extracted in a state of being elongated.

Therefore, after finishing to transcribe, when the application head is detached from the transcribed face, the elongated transcribing tape is returned in a direction of the supply reel by being contracted to recover, and only the tape exfoliated with the coating film remains on the transcribing roller.

Therefore, in starting to use successively, coating film detachment of the transcribing tape is brought about at the application head, even when the application head is pressed to the transcribed face, since a coating film is not present on the tape, there poses a problem that a non-transcribed portion in accordance with an amount of returning the tape is brought about at the transcribed face to constitute a factor of idle slip.

### SUMMARY OF THE INVENTION

In view of the problems involved with the prior art, it is an object of the invention to provide an improved coating film transfer tool. In particular it is an object of the invention to provide a coating film transfer tool capable of firmly preventing a non-transcribing portion from being brought about at a transcribed face by coating film detachment of a transcribing tape at an application head and eliminating idle slip at every time of starting to be used.

According to the invention, these objects are achieved by a coating film transfer tool comprising a first gear mounted to a supply reel, a second gear rotating in common with the first gear and mounted to a take-up reel for reeling a transcribing tape wound around the supply reel by the take-up reel along an application head projected from a front end opening of a case main body at inside of the case main body, a protecting cover provided at a front end portion of the case main body and slidably disposed for moving in a front and rear direction between an advanced position in a state of covering the application head and a rear position in a state of exposing the application head, said protecting cover being urged in a direction of the advanced position by a spring; a tape reel out means provided inside of the case main body for reeling out the transcribing tape to the application head, and a driving means for moving the protecting cover to the rear position for enabling the tape reel out means for reeling out the transcribing tape to the application head.

Accordingly a coating film transfer tool provided with a first gear mounted with a supply reel, and a second gear moved in cooperation with the first gear and mounted with a take-up reel for reeling a transcribing tape wound around the supply reel by the take-up reel by way of an application head projected from a front end opening of a case main body at inside of the case main body, wherein a front end portion of the case main body is provided with a protecting cover made to be slidable in a front and rear direction between an advanced position in a state of covering the application head and a rear position in a state of exposing the application head, and the protecting cover is urged in a direction of the advanced position by a spring, and inside of the case main body is provided with tape reel out means for reeling out the transcribing tape to the application head, and the tape reel out means is made to be able to reel out the transcribing tape to the application head by operating driving means in starting to be used by moving the tape reel out means in cooperation with driving means for moving the protecting cover to the rear position by providing the tape reel out means for reeling out the transcribing tape to the application head.

In accordance with an embodiment of the invention the driving means is constituted by an upward/downward movable press member provided by being projected to an upper side of an outer periphery of a front end portion of the case main body, and a sliding face integrally provided with the protecting cover and inclined to be lowered to a front side to be able to be brought into sliding contact with the press member, and the protecting cover is made to be able to be moved to the rear position against an urge force of a spring by pressing the press member to a lower side.

In accordance with another embodiment of the invention the tape reel out means is constructed by a constitution including at least a rack moved in cooperation with a movement of the protecting cover in the front and rear direction, and a pinion which is brought in mesh with the rack and the first gear in moving the protecting cover to the rear position and is not brought in mesh with the first gear in moving the protecting cover to the advanced position.

Preferably the pinion is detached from the rack at the rear position of the protecting cover. Moreover it is preferred that the pinion is made to be able to be detached from the first gear to an original position at which the pinion has been disposed when the protecting cover is disposed at the advanced position after having been detached from the rack.

According to the invention, the following effect is achieved.

Since the front end portion of the case main body is provided with the protecting cover made to be slidable in the front and rear direction between the advanced position in the state of covering the application head and the rear position in the state of exposing the application head, the protecting cover is urged in the direction of the advanced position by the spring, inside of the case main body is provided with the tape reel out means for reeling out the transcribing tape to the application head, the tape reel out means is moved in cooperation with the driving means for moving the protecting cover to the rear position to operate the driving means in starting to be used, the transcribing tape is made to be able to reel out to the application head, and therefore, at every time of starting to be used, by operating the driving means, the protecting cover is moved from the advanced position to the rear position, the transcribing tape can automatically be reeled out to the application head, a nontranscribing portion can firmly be prevented from being brought about at the transcribed face, and idle slip can be eliminated.

Since the driving means according to an embodiment of the invention is constituted by the upward/downward movable press member provided by being projected to the upper side of the outer periphery of the front end portion of the case main body, and the sliding face provided integrally with the protecting cover and inclined to be lowered to the front side to be able to be brought into sliding contact with the press member, the protecting cover is made to be able to be moved to the rear position against the urge force of the spring by pressing the press member to the lower side, the driving means can be constituted by a comparatively simple structure, at every time of starting to be used, by simply pressing the press member to the lower side, the transcribing tape can be reeled out to the application head by moving the protecting cover firmly to the rear position.

Since the tape reel out means according to another embodiment of the invention is constructed by the constitution at least including the rack moved in cooperation with the movement of the protecting cover in the front and rear direction, and the pinion movable to be able to be brought in mesh with the rack in advancing the protecting cover and brought in mesh with the first gear by moving the rack in moving back the protecting cover, the driving means can be constituted by a comparatively simple structure, at every time of starting to be used, by simply pressing the press member to the lower side, the transcribing tape can be reeled out to the application head by moving the protecting cover firmly to the rear position.

Since the pinion is made to be detached from the rack at the rear position of the protecting cover, the transcribing tape can smoothly be reeled out to the application head at every time of starting to be used.

Since the pinion is made to be able to be detached from the first gear after having been detached from the rack and made to be able to be detached to the original position at which the pinion has been disposed when the protecting cover is disposed at the advanced position, the transcribing tape can smoothly be reeled out to the application head in starting to be used successively.

The accompanying drawings which are incorporated in and constitute part of the present specification, are included to illustrate and provide for a further understanding of the invention.

### BRIEF DESCRIPTION OF THE DRAWINGS

FIG. 1 is a perspective view of a coating film transfer tool according to an embodiment of the invention showing an application head in a state of protecting it when not used;

FIG. 2 is a partially broken perspective view of the coating film transfer tool shown in FIG. 1;

FIG. 3 is a perspective view of the coating film transfer tool shown in FIG. 1 in a state of being viewed up from a lower side thereof;

FIG. 4 is a vertical sectional side view of the coating film transfer tool shown in FIG. 1;

FIG. 5 is a perspective view of the coating film transfer tool showing a state of reeling out a transcribing tape in a half exposed state of the application head in starting to be used;

FIG. 6 is a vertical sectional side view of the coating film transfer tool shown in FIG. 5;

FIG. 7 is a perspective view of the coating film transfer tool showing a state of exposing an application head when used; and

FIG. 8 is a vertical sectional side view of the coating film transfer tool shown in FIG. 7.

### DETAILED DESCRIPTION OF THE PREFERRED EMBODIMENT

An embodiment of the invention will be explained as follows with reference to the attached drawings.

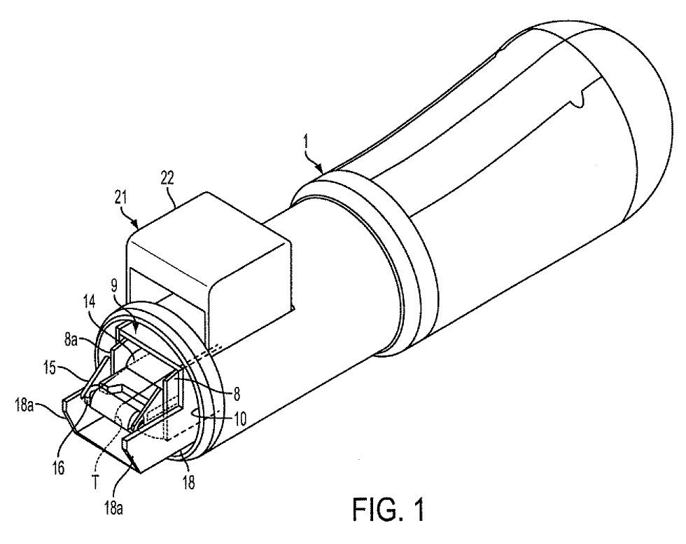

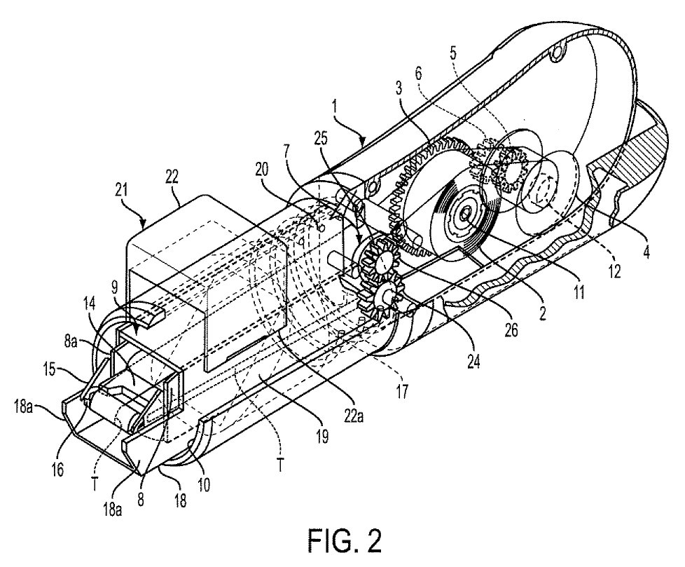

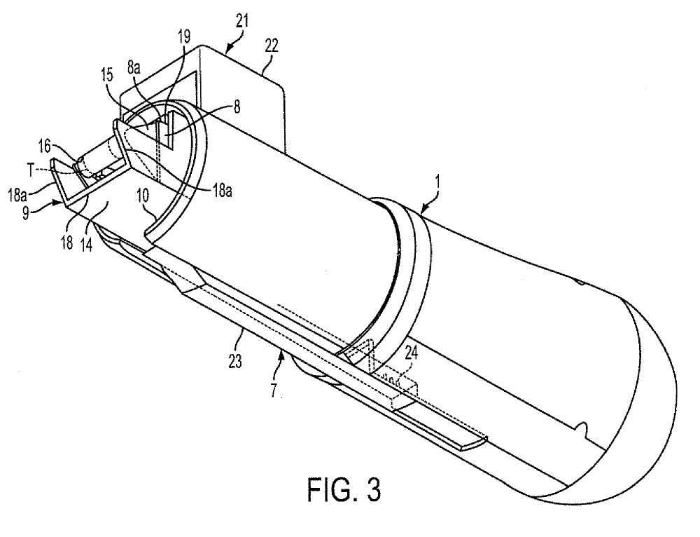

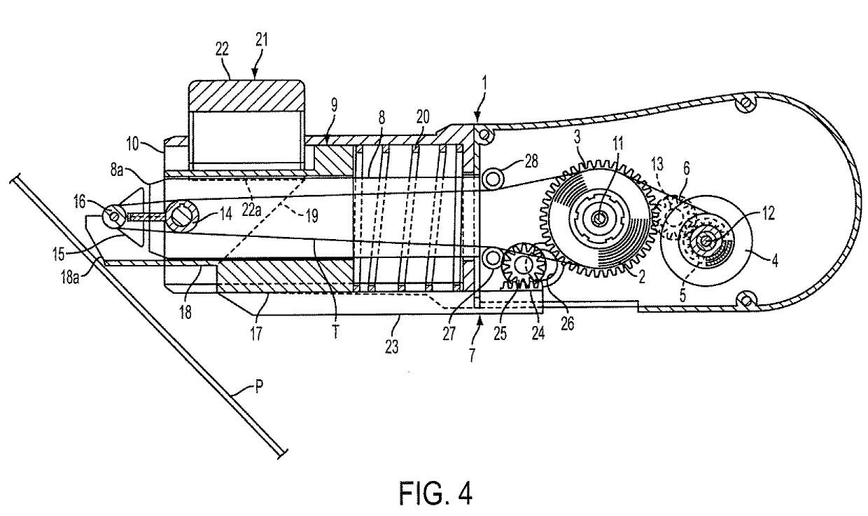

As shown in FIG. 1 to FIG. 4, the coating film transfer tool of the invention includes a first gear 3 mounted with a supply reel 2 wound with a transcribing tape T, a second gear 5 mounted with a take-up reel 4 for reeling a transcribing tape T after having finishing a transcribing operation, a third gear 6 indirectly brought in mesh with the first gear 3 and the second gear 5, and tape reel out means 7 as shown by FIG. 2, FIG. 4 at a rear portion of inside of a case main body 1 having a cylindrical shape and formed by a synthetic resin, includes an application head support member 8 and a protecting cover 9 at a front portion of the inside of the case main body 1.

The case main body 1 has an opening 10 at a front end thereof and is provided with a support shaft 11 of the first gear 3 mounted with the supply reel 2, a support shaft 12 of the second gear 5 mounted with the take-up reel 4, a support shaft 13 of the third gear 6 indirectly brought in mesh with the first gear 3 and the second gear 5 at an inner side wall of a rear portion thereof.

As shown in FIG. 2 and FIG. 4, the application head support member 8 is held by a front portion at inside of the case main body 1, and is provided with an application head 15 attached to a tape guide member 14 at a front end thereof. The application head 15 is projected from the opening 10 at the front end of the case main body 1 along with a front end portion 8a of the application head support member 8, and is rotatably attached with a transcribing roller 16 at a front end thereof.

The protecting cover 9 includes a barrel portion 17 slidably fitted to the front portion of inside of the case main body 1 and formed in a cylindrical shape by a synthetic resin, a protecting rod 18 having a section in a trough-like shape extended to a front side from a lower end of the barrel portion 17, projecting the front end portion from the opening 10 and made to be able to protect the application head 15 from an outer side by two left and right side walls 18a, 18a and a sliding contact face 19 formed at a boundary portion of the protecting rod 18 and the barrel portion 17 and inclined to be lowered to the front side.

The protecting cover 9 is urged to a front side by a coil spring 20 contained at a rear side of the barrel portion 17 at the front portion of inside of the case main body 1. When not used, the protecting cover 9 is maintained at an advanced position in a state of covering left and right side faces of the application head 15, and when started to be used, the protecting cover 9 is moved to a rear position in a state of exposing the application head from the advanced position by operating driving means 21.

The driving means 21 is provided with an upward/downward movable press member 22 provided to project to an upper side at an outer periphery of a front end portion of the case main body 1 and is arranged such that a lower end portion 22a of the press member 22 comes into sliding contact with the sliding contact face 19 formed at the protecting cover 9.

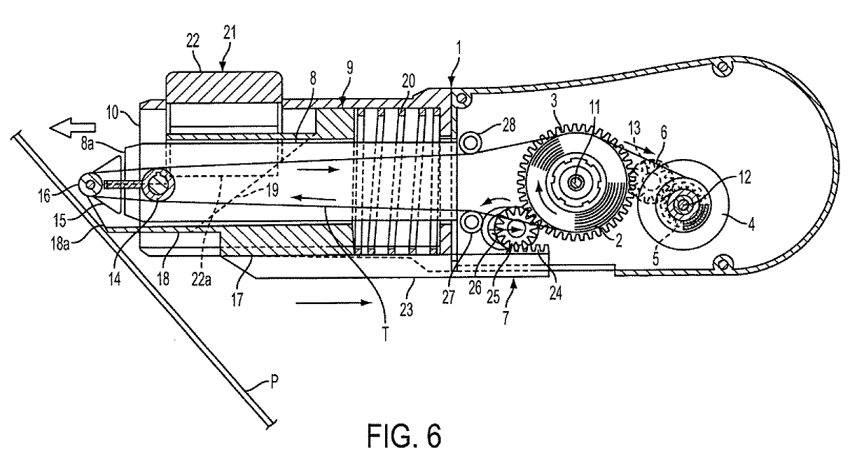

As shown in FIG. 6, in starting to be used, when the press member 22 is pressed to a lower side, the lower end portion 22a thereof is lowered for getting into sliding contact with the sliding contact face 19 of the protecting cover 9 to press, thereby the protecting cover 9 is moved to the rear position. In cooperation with the movement of the protecting cover 9, the tape reel out means 7 mentioned later is operated for reeling out the transcribing tape T to the application head 15.

The tape reel out means 7 includes an operating rod 23 moved in cooperation with a movement of the barrel portion 17 of the protecting cover 9 in the front and rear direction, a rack 24 moved in cooperation with the movement of the operating rod 23 in the front and rear direction, a pinion 25 brought in mesh with the rack 24, and a long hole 26 making the pinion 25 movable in the front and rear direction and bringing the pinion 25 into contact to be brought in mesh with the first gear 3 mounted with the supply reel 2 and separating the pinion 25 from the first gear 3.

As shown in FIG. 4, the pinion 25 is brought in mesh with the rack 24 at the advance position of the protecting cover 9 when not used and is made to be movable to be able to be brought in mesh with the first gear 3 mounted with the supply reel 2 by moving the rack 24 in moving back the protecting cover 9 when started to be used as shown in FIG. 6.

The pinion 25 rotates the supply reel 2 by being brought in mesh with the first gear 3 from a state of being brought in mesh with the first gear 3 in accordance with moving back the protecting cover 9 in starting to be used, and reels out the transcribing tape T wound around the supply reel 2 by a length in accordance with the amount of rotating the pinion 25.

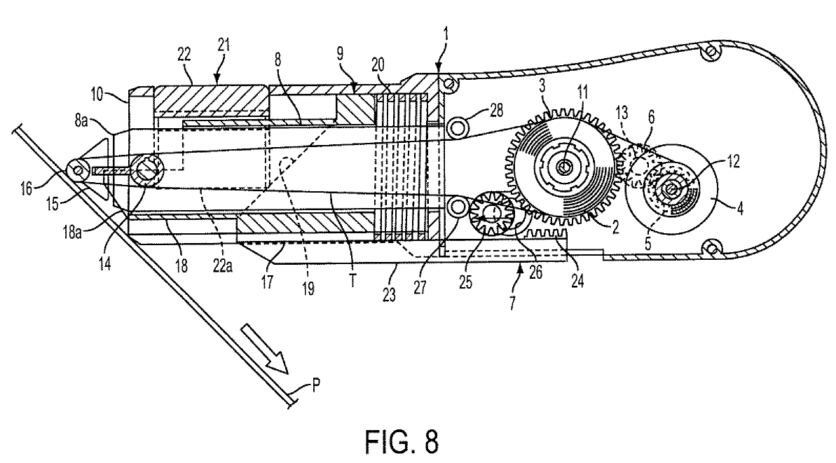

On the other hand, at the rear position of the protecting cover 9 shown in FIG. 8, the pinion 25 is made to be able to be idled by being detached from the rack 24. After detaching from the rack 24, the pinion 25 is made to be able to be detached from the first gear 3 by being guided by the long hole 26 and when the protecting cover 9 is disposed at the advanced position, the pinion 25 is made to be able to be detached to an original position at which the pinion 25 has been disposed.

Thereby, the pinion 25 is brought in mesh with the rack 24 and the first gear 3 in moving the protecting cover 9 to the rear position and is prevented from being brought in mesh with the first gear 3 in moving the protecting cover 9 to the advanced position.

The transcribing tape T is reeled from the supply reel 2 to the reeling roller 4 by way of a first guide pin 27, the transcribing roller 16 of the application head 15 and a second guide pin 28.

Next, a procedure of operating the coating film transfer tool according to the invention will be explained.

As shown in FIG. 2, FIG. 4, when not used, the protecting cover 9 is urged to project to the front side from the opening 10 at the front end of the case main body 1 by the coil spring 20 disposed at the rear side of the barrel portion 17 at the front portion at inside of the case main body 1 and is maintained at the advanced position in the state of covering the left and right side faces of the application head 15 by the left and right side walls 18a, 18a at the front end portion of the protecting rod 18.

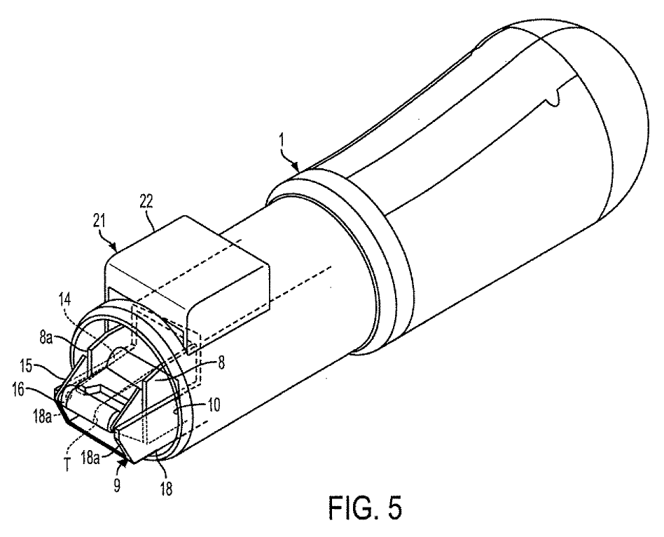

In starting to be used, as shown in FIG. 5 and FIG. 6, a portion of the application head 15 is half exposed by moving the protecting cover 9 to the rear position by lowering the lower end portion 22a for pressing the sliding contact face 19 of the protecting cover 9 by pressing the press member 22 of the driving means 21 to the lower side by a finger tip, not illustrated.

At this occasion, the pinion 25 of the tape reel out means 7 is moved to the rear side in cooperation with the rack 24 moved back by way of the operating rod 23 by moving back the protecting cover 9 to be brought in mesh with the first gear 3 and is rotated by further moving back the rack 24 to rotate the first gear 3.

Thereby, the transcribing tape T wound around the supply reel 2 is reeled out automatically by a length in accordance with an amount of rotating the pinion 25 to be supplied onto the transcribing roll 16 of the application head 15.

Therefore, in starting to be used, the transcribing tape T holding the coating film can be disposed on the transcribing roll 16 for preventing coating film detachment.

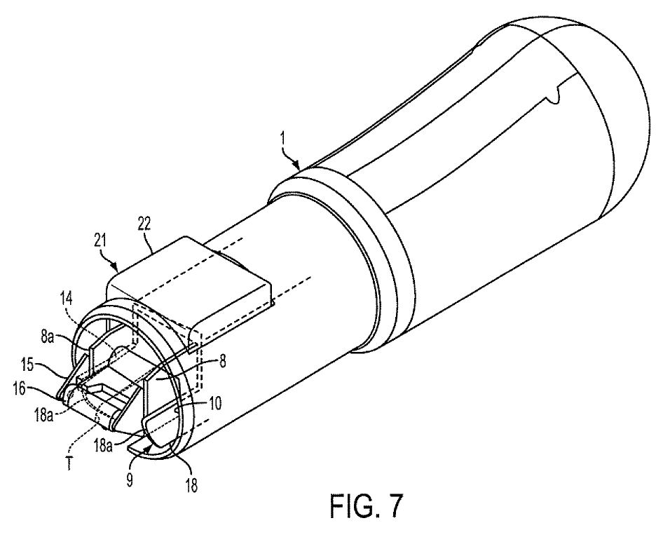

As shown in FIG. 7 and FIG. 8, when the press member 22 is further pressed to a lower side, the lower end portion 22a is lowered to be brought into sliding contact with and to press the sliding contact face 19 of the protecting cover 9 thereby the protecting cover 9 is moved to the rear position, so that the application head 15 is completely exposed from the protecting cover 9, and the pinion 25 is idled by being detached from the rack 24.

When the application head 15 is slid in the arrow mark direction of FIG. 8, a coating film of a glue, a correcting solution or the like can be transcribed onto a paper face P by drawing out the transcribing tape T from the supply reel 2 due to a friction resistance produced between the transcribing tape T and the paper face P.

The transcribing tape T after having been transcribed is reeled by the take-up roller 4 rotated in synchronism with the first gear 3 by way of the third gear 6 and the second gear 5, and the pinion 25 detached from the rack 24 is separated from the first gear 3 by its own weight to return to the original position at which the pinion 25 has been disposed when the protecting cover 9 has been disposed at the advanced position.

Further, the pinion 25 may be constituted to be able to return to the original position by an urge force of a spring or the like.

After having been transcribed, when the finger tip is detached from the press member 22, the state of pressing the press member 22 is released, the press member 22 brought into sliding contact with the sliding contact face 19 is urged up in accordance with moving the protecting cover 9 to the front side by the urge force of the coil spring 20, and the press member 22 is returned to the original position before having been pressed shown in FIG. 4. At the same time, also the protecting rod 18 is moved to the original advanced position to cover the application head 15 to protect the transcribing tape T.

The above description of preferred embodiments has been given by way of example. From the disclosure given, those skilled in the art will not only understand the present invention and the attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A coating film transfer tool comprising a first gear mounted to a supply reel, a second gear rotating in common with the first gear and mounted to a take-up reel for reeling a transcribing tape wound around the supply reel by the take-up reel along an application head projected from a front end opening of a case main body at inside of the case main body, a protecting cover provided at a front end portion of the case main body and slidably disposed for moving in a front and rear direction between an advanced position in a state of covering the application head and a rear position in a state of exposing the application head, said protecting cover being urged in a direction of the advanced position by a spring; a tape reel out means provided inside of the case main body for reeling out the transcribing tape to the application head, and a driving means for moving the protecting cover to the rear position for enabling the tape reel out means for reeling out the transcribing tape to the application head.

2. The coating film transfer tool according to claim 1, wherein the driving means comprises an upward/downward movable press member projecting from an upper side of an outer periphery of a front end portion of the case main body, and a sliding face integrally provided with the protecting cover and inclined to be lowered to a front side to be able to be brought into sliding contact with the press member, said protecting cover is adapted to be moved to the rear position against the urge force of said spring by pressing the press member to a lower side.

3. The coating film transfer tool according to claim 1, wherein the tape reel out means includes at least a rack moved in cooperation with a movement of the protecting cover in the front and rear direction, and a pinion which is in mesh with the rack and the first gear when moving the protecting cover to the rear position and is not in mesh with the first gear in moving the protecting cover to the advanced position.

4. The coating film transfer tool according to claim 3, wherein the pinion is detached from the rack at the rear position of the protecting cover.

5. The coating film transfer tool according to claim 4, wherein the pinion is adapted to be detached from the first gear to an original position at which the pinion has been disposed when the protecting cover is disposed at the advanced position after having been detached from the rack.
